(19) United States
(12) Patent Application Publication
(10) Pub. No.: US 2003/0064757 A1
(43) Pub. Date: Apr. 3, 2003

(54) Method of displaying information on a screen

(76) Inventors: Hitoshi Yamadera, Kokubunji (JP); Satoko Kojima, Tokyo (JP); Fumihiro Harigai, Hitachinaka (JP); Junichi Yoshida, Hitachinaka (JP)

Correspondence Address: MATTINGLY, STANGER & MALUR, P.C., SUITE 370, 1800 DIAGONAL ROAD, ALEXANDRIA, VA, 22314, US

(21) Appl. No.: 10/226,156

(22) Filed: Aug. 23, 2002

(30) Foreign Application Priority Data
Oct. 1, 2001 (JP) 2001-304816

(51) Int. Cl. H04M 1/00; H04B 1/38; G09G 5/00

(52) U.S. Cl. 455/566; 345/841; 345/864

(57) ABSTRACT

A first home position icon and a plurality of second home position icons, which are first hierarchical level icons, are displayed on a menu item selection screen. When one of the second home position icons is selected, second hierarchical level submenus, as well as the first home position icon and the second home positions, are displayed on the menu item selection screen in a direction perpendicular to a direction in which the selected second home position icon is located with respect to the first home position icon. When one of the displayed submenus is selected, a third hierarchical level menu is displayed on a submenu screen.

### BACKGROUND OF THE INVENTION

The present invention relates to the display part of an information device such as a cellular phone or a PDA terminal, and more particularly to a method for displaying information on the screen of a display part.

As a variety of functions including mail communication, Internet communication, and schedule management are added, an information device such as a cellular phone and a PDA terminal has become very convenient.

Such an information device has two parts: a display part and an operation part. The user selects a menu item from the display screen of the display part via the operation part and confirms the selected one to run various functions. As prior-art examples, the display screens shown in FIGS. 24A-24C (prior-art example 1, see, for example, JP-A-2001-245030 laid-open on Sep. 7, 2001) and those shown in FIGS. 25A-25C (prior-art example 2) are known.

In prior-art example 1, a menu screen including menu item icons 231a, 231b, 231c, 231d, and 231e is displayed on a display screen 230a of a display part 230 as shown in FIG. 24A. With this menu screen displayed, the user operates the operation part, not shown, to move a cursor 232 to select a menu item as shown in FIG. 24B. After selecting a menu item, the user further operates the operation part to display submenu items on the display screen 230a as shown in FIG. 24C.

In prior-art example 2, a menu screen including 3-by-3 menu items 233a, 233b, 233c, 233d, 233e, 233f, 233g, 233h, and 233k is displayed on the display screen 230a of the display part 230 as shown in FIG. 25A. With this menu screen displayed, the user operates the operation part, not shown, to move the cursor 232 to select a menu item as shown in FIG. 25B. After selecting a menu item, the user further operates the operation part to display 3-by-3 submenu items 234a, 234b, 234c, 234d, 234e, 234f, 234g, 234h, and 234k on the display screen 230a as shown in FIG. 25C.

In prior-art example 1 and prior-art example 2 described above, when the user confirms a menu item to display the submenu items of the menu item and, after that, wants to select another menu item, the user must once return to the menu screen shown in FIG. 24A or FIG. 25A. In those prior-art examples, there has been no consideration for operability.

In prior-art example 1 and prior-art example 2 in which the menu items constituting the first hierarchical level and the submenu items constituting the second hierarchical level are displayed on separate screens, no path (history) from the first hierarchical level to the second hierarchical level is displayed. This makes it difficult for the user to keep track of the selection status of menu items. There has been no consideration for the user to keep track of selected contents.

### SUMMARY OF THE INVENTION

It is an object of the present invention to provide a method of displaying information on a screen for increasing operability.

It is another object of the present invention to provide a method of displaying information on a screen that solves the above problems and that help the user to easily understand and confirm menu item selection status.

According to one aspect of the present invention, a first home position icon and a plurality of second home position icons both at a first hierarchical level are displayed on a first display screen. When one of the displayed second home position icons is selected, submenu icons at a second hierarchical level are displayed on the first display screen, with the first and second home position icons, in a direction perpendicular to the direction of the selected second home position icon. When one of the displayed submenu icons is selected, third hierarchical level submenus are displayed on a second display screen.

According to another aspect of the present invention, the submenu icons are displayed on the first display screen with the unselected second home position icons, wherein the submenu items are displayed in a direction perpendicular to a direction in which the selected second home position icon is located with respect to the first home position icon. The unselected second home position icons are dimmed.

According to still another aspect of the present invention, the first home position icon, which has a setting function, is displayed in the center of the first display screen with the second home position icons around the first home position icon.

Other objects, features and advantages of the invention will become apparent from the following description of the embodiments of the invention taken in conjunction with the accompanying drawings.

### BRIEF DESCRIPTION OF THE DRAWINGS

FIG. 1 is an external view of a cellular phone in an embodiment of the present invention.

FIG. 2 is a diagram showing an example of the menu structure of the cellular phone in the embodiment of the present invention.

FIG. 3 is a block diagram showing the hardware configuration of the cellular phone in the embodiment of the present invention.

FIG. 4 is an operation flowchart in the embodiment of the present invention.

FIGS. 5A-5E are diagrams showing an example of screen transition of the display screen in the embodiment of the present invention.

FIGS. 6A-6D are diagrams showing an example of screen transition of the display screen in the embodiment of the present invention.

FIGS. 7A-7D are diagrams showing an example of screen transition of the display screen in the embodiment of the present invention.

FIGS. 8A-8B are diagrams showing an example of screen transition of the display screen in the embodiment of the present invention.

FIGS. 9A-9B are diagrams showing an example of screen transition of the display screen in the embodiment of the present invention.

FIGS. 10A-10C are diagrams showing the configuration of an AV system in an embodiment of the present invention.

FIGS. 11A-11B are block diagrams showing the hardware configuration of the AV system in the embodiment of the present invention.

FIG. 12 is a diagram showing an example of the menu structure of a television set in the embodiment of the present invention.

FIG. 13 is a diagram showing an example of the menu structure of a video cartridge recorder in the embodiment of the present invention.

FIG. 14 is a diagram showing the usage status of a DVD camera in an embodiment of the present invention.

FIG. 15 is a block diagram showing the hardware configuration of the DVD camera in the embodiment of the present invention.

FIG. 16 is a diagram showing an example of the DVD camera menu structure in the embodiment of the present invention.

FIG. 17 is an external configuration diagram of a PC system in an embodiment of the present invention.

FIG. 18 is a block diagram showing the hardware configuration of the PC system in the embodiment of the present invention.

FIG. 19 is a diagram showing an example of the menu structure of the PC system in the embodiment of the present invention.

FIG. 20 is an external configuration diagram of an Internet appliance terminal in the embodiment of the present invention.

FIG. 21 is an external configuration diagram of a PDA terminal in an embodiment of the present invention.

FIG. 22 is a block diagram showing the hardware configuration of the PDA terminal in the embodiment of the present invention.

FIG. 23 is a diagram showing an example of the menu structure of the PDA terminal in the embodiment of the present invention.

FIGS. 24A-24C are diagrams showing a prior art example.

FIGS. 25A-25C are diagrams showing another prior art example.

### DETAILED DESCRIPTION OF THE EMBODIMENTS

Some embodiments of the present invention will be described below with reference to the drawings. In the drawings, the same reference numerals denote the same or corresponding structural elements, and the duplicate description will be omitted.

### First Embodiment

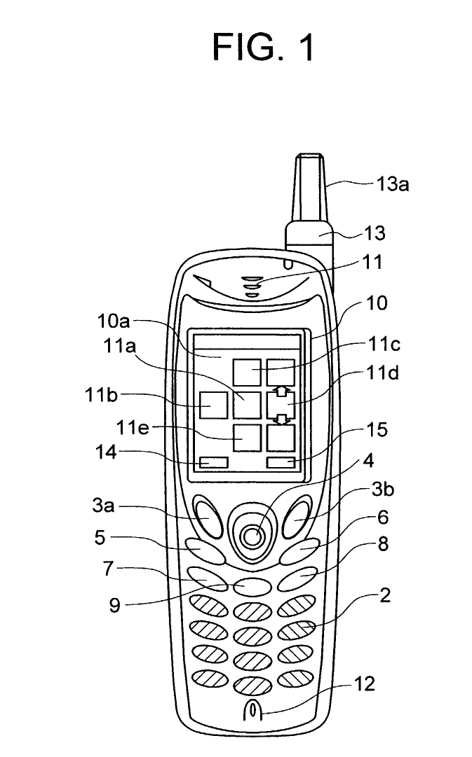

First, with reference to FIGS. 1-4 and FIG. 5A-5E, a menu screen and a display method in one embodiment of the present invention, which are applied to a cellular phone, will be described.

FIG. 1 is an external view of a cellular phone in the embodiment of the present invention. Referring to FIG. 1, the cellular phone comprises dial keys 2 (12 keys indicated by hatching), left soft key 3a, right soft key 3b, cursor key 4, mail key 5, web key 6, send key 7, end key 8, clear key 9, display part 10, display screen 10a, speaker 11, microphone 12, GPS antenna 13, and antenna 13a.

The dial keys 2, each assigned a number and an alphabetic character, are used for entering numbers and characters. The left soft key 3a and the right soft key 3b are used primarily for running various functions such as a phone directory calling, a voice message, and a voice memo. The cursor key 4, which may be moved in four directions (up/down, right/left), is used to select menu items from the display screen 10a. The cursor key 4, which also has the pushbutton function, allows the user to press the cursor key 4 to confirm a menu item that has been selected.

The mail key 5 is used to send and receive mails, and the web key 6 to connect to a web site such as the Internet.

The send key 7 is used to make a call or send mails, and the end key 8 to end a phone call or to return the display of the display screen 10a to the stand-by screen.

The clear key 9 is used to delete characters during character entry or to return the display screen 10a from the menu item selection screen to the stand-by screen.

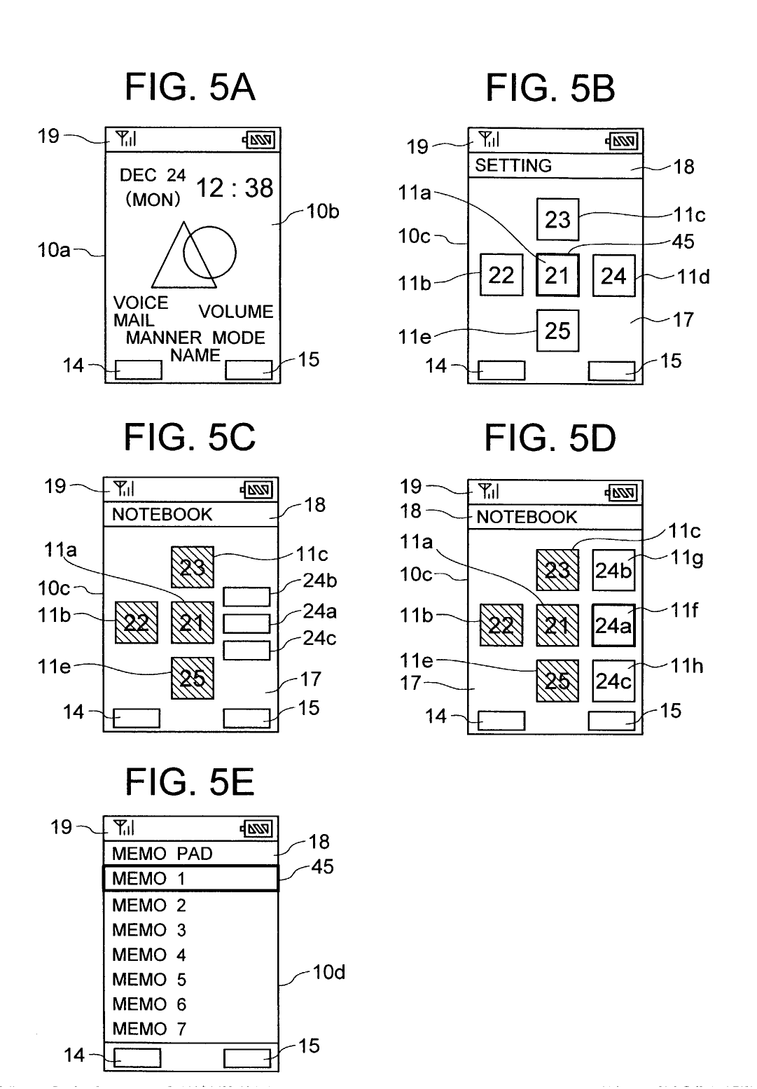

The display screen 10a has three display areas: a first display area 17 in which menu item icons 11a, 11b, 11c, 11d, and 11e, an icon 14 displaying the function of the left soft key 3a, and an icon 15 displaying the function of the right soft key 3b are displayed; a second display area 18 in which selected menu items are displayed; and a third display area 19 in which the radio reception level and the battery level are displayed (see FIG. 5).

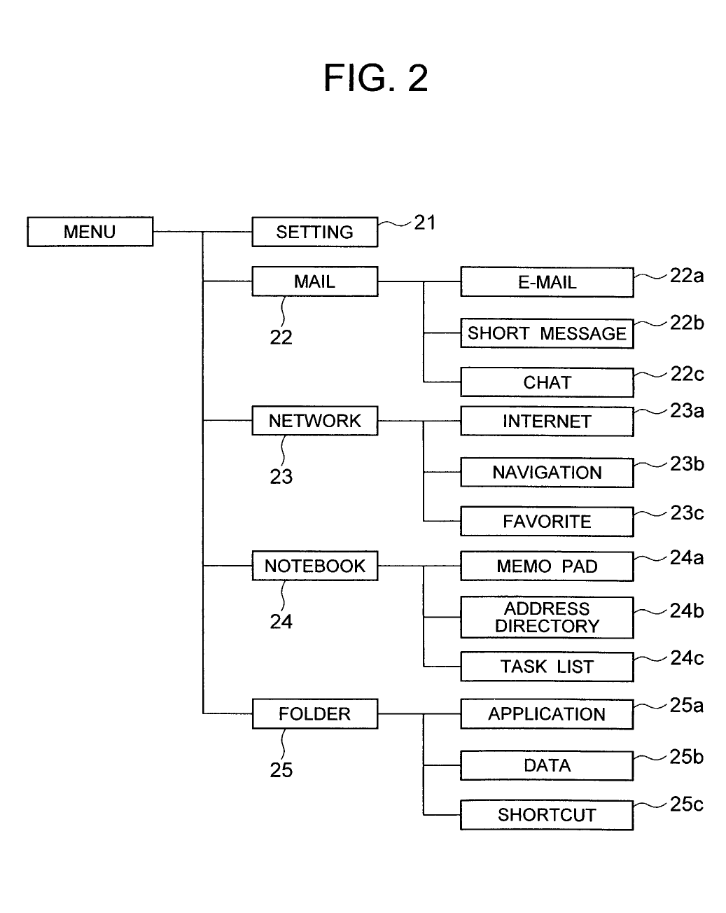

FIG. 2 is a diagram showing an example of the menu structure of the cellular phone in the embodiment of the present invention. Referring to FIG. 2, the menu items of the cellular phone in the embodiment comprise a setting menu 21 used to determine the various settings of the cellular phone, a mail menu 22 used to start the mail function, a network menu 23 used to connect to a network, a notebook menu 24 used to add and call phone numbers, mail addresses, and memos, and a folder menu 25 used to save and call applications and data. These menu items constitute the first hierarchical level (major classification). Each menu item of the first hierarchical level has submenus that constitute a second hierarchical level (minor classification).

The mail menu 22 has a submenu 22a used to send and receive electronic mails, a submenu 22b used to send short messages (short mails), and a submenu 22c used to have a chat.

The network menu 23 has a submenu 23a used to connect to web sites on the Internet, a submenu 23b used to connect to the navigation function for obtaining positional information, and a submenu 23c used to connect directly to frequently visited web sites registered by the user in advance.

The notebook menu 24 has a submenu 24a used to add and call phone numbers and mail addresses, a submenu 24b used to write on or call a memo pad, and a submenu 24c used to add and call tasks (schedules, etc.)

The folder menu 25 has a submenu 25a used to call applications such as game programs downloaded to the cellular phone, a submenu 25b used to call various types of data such as wallpapers and ringing tones used on the stand-by menu, and a submenu 25c used to connect to frequently used functions registered by the user.

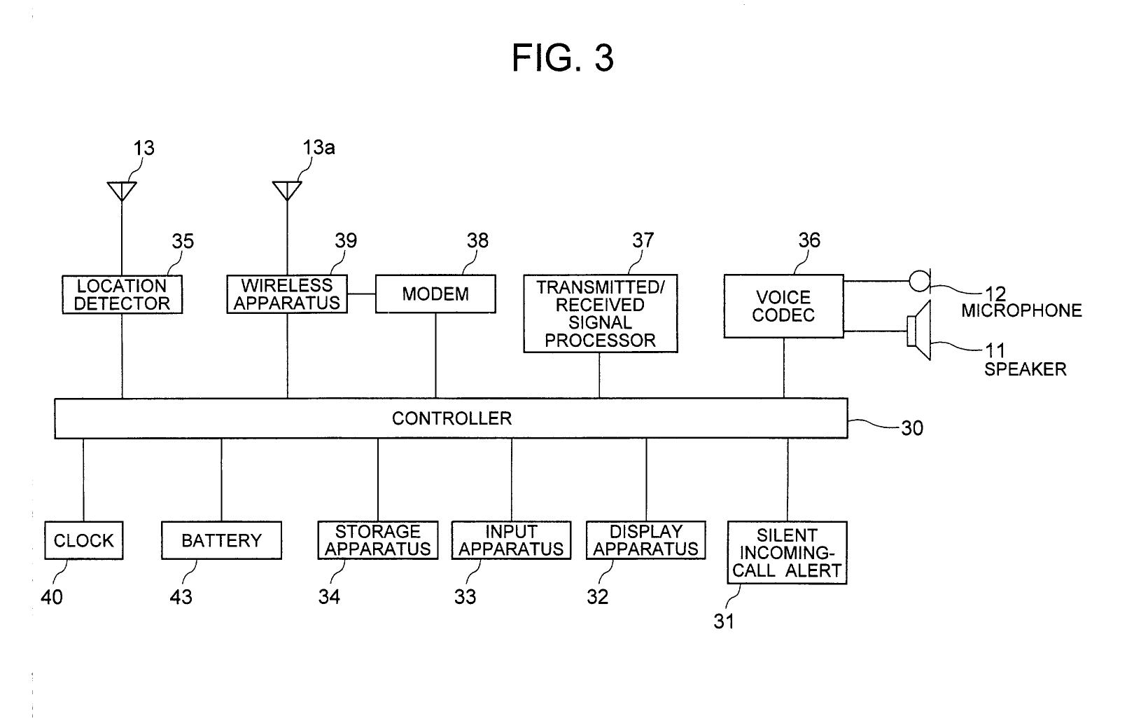

FIG. 3 is a block diagram showing the hardware configuration of the cellular phone in the embodiment of the present invention. Referring to FIG. 3, the power is supplied from a battery 43 to the components of the cellular phone to perform a predetermined operation based on information entered from an input apparatus 33 under control of a controller 30. The input apparatus 33 corresponds to the function keys, dial keys 2, and cursor key 4. A display apparatus 32 corresponds to the display part 10 and the display screen 10a.

When a phone call is made through the input apparatus 33, voice signals entered from the microphone 12 are coded by a voice CODEC (Coder/Decoder) 36, modulated by a modem 38 for transmission to a wireless apparatus 39, and then sent from the antenna 13a. Signals received by the antenna 13a are supplied to the modem 38 via the wireless apparatus 39, demodulated by the modem 38, decoded to voice signals by the voice CODEC 36, and then output from the speaker 11 as voices. Upon receiving a call from a caller, the controller 30 activates a silent incoming-call alert 31, such as a vibrator, to inform the user of an incoming call. Of course, a ringing tone may be output from the speaker 11.

When the user presses the web key 6 or the cursor key 4 of the input apparatus 33 to make a web service request via the Internet, the request is sent from the wireless apparatus 39 via the antenna 13a. When a connection is established with a predetermined server, information is received from the predetermined server, demodulated by the modem 38 for display on the display screen 10a of the display apparatus 32 and, as necessary, stored in a storage apparatus 34.

A mail, when received via the antenna 13a, is demodulated by the modem 38 and is stored in the storage apparatus 34. The controller 30 displays a mail icon (not shown) on the display screen 10a of the display apparatus 32 to inform the user that the mail has been received. The user, who confirms the reception of the mail, uses the mail key 5 or the cursor key 4 of the input apparatus 33 to retrieve the received mail from the storage apparatus 34 and display the received mail on the display screen 10a of the display apparatus 32. The user, who wishes to send a mail, uses the mail key 5 or the cursor key 4 of the input apparatus 33 to open the mail creation menu and operates the input apparatus 33 to enter mail text. The entered mail is modulated by the modem 38 and then sent from the wireless apparatus 39 for wireless transmission via the antenna 13a.

When the user wants to display location information via the GPS antenna 13, he or she operates the cursor key 4 of the input apparatus 33 to open the location information display menu. When the user enters the current location information and the destination location information, the controller 30 determines the current location information and the destination information via a location detector 35, the wireless apparatus 39, and the GPS antenna 13 and transmits the determined information via the antenna 13a. The transmitted current location information and the destination location information are received, for example, by a server that has geographic information. The server matches the received current location information or the destination location information with the geographic information it has and transmits relative location data on the current location and the destination location as well as the geographic data on the current location. The transmitted relative location data and the geographic data are received via the antenna 13a, wireless apparatus 39, and controller 30, and the received relative location data and the geographic data are displayed on the display screen 10a of the display apparatus 32. Note that the received relative location data and the geographic data may also be stored in the storage apparatus 34 as necessary.

The controller 30 obtains the current date/time information from a clock 40. The current date/time is displayed on the display screen 10a of the display apparatus 32, and the display screen 10 is changed to the standby screen 10a (see FIG. 5). The controller 30 also monitors the level of radio wave reception and the level of battery 43 at all times and displays the level of radio wave reception and the level of the battery 43 on the display screen 10a as necessary.

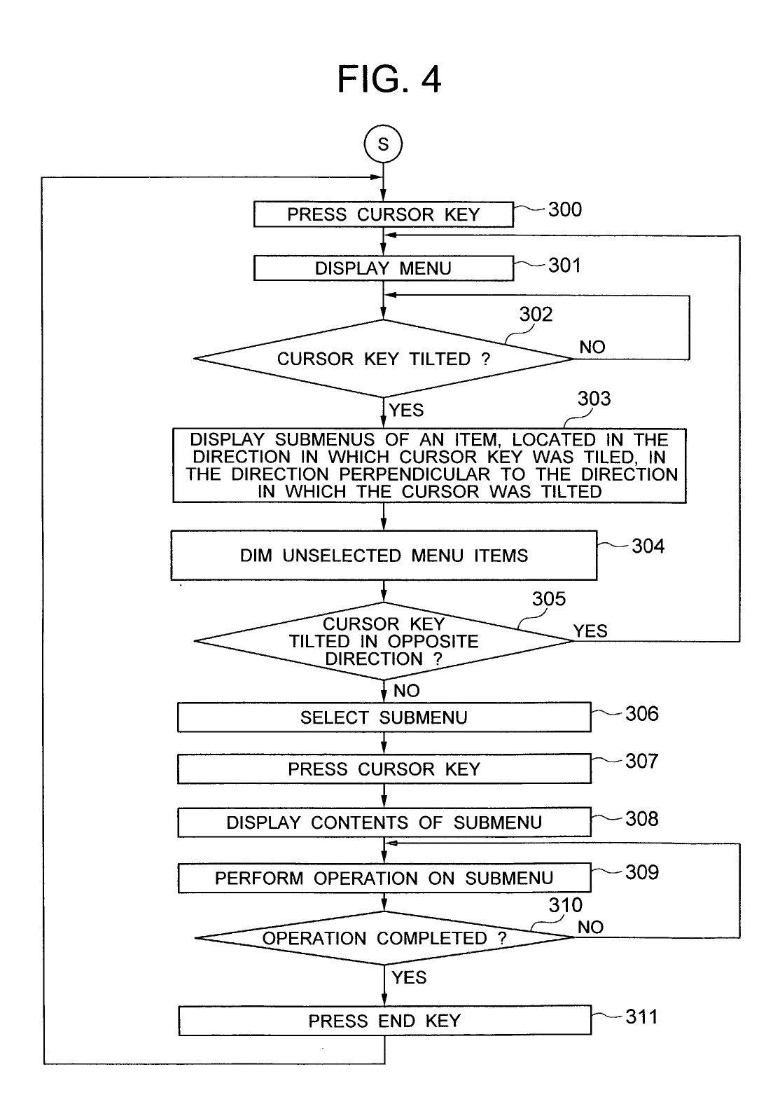

Next, referring to FIG. 4 to FIG. 6, the operation that is performed when menu items are selected, as well as screen transition, will be described.

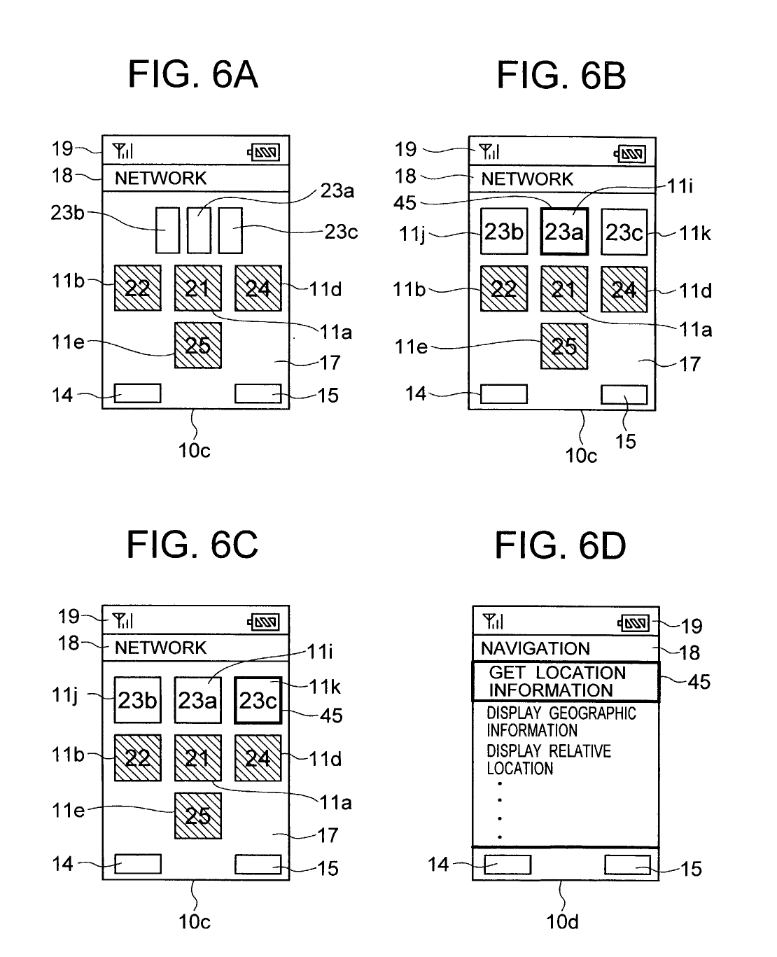

FIG. 4 is a flowchart showing the operation of the embodiment of the present invention, and FIGS. 5A-5E and FIGS. 6A-6D are diagrams showing an example of the screen transition of the display screen in the embodiment of the present invention. In FIG. 4 and FIGS. 5A-5E, when the user presses the cursor key 4 (step 300) with a standby screen 10b in FIG. 5A displayed on the display screen 10a, the display on the display screen 10a switches to a menu item selection screen 10c, the first display screen, as shown in FIG. 5B (step 301). On this screen, the first home position icon and the second home position icons, which are the base icons of the first hierarchical level, are displayed. In this embodiment, the icon 11a is displayed in the center of the menu item selection screen 10c as the first home position icon and, around the icon 11a, icons 11b, 11c, 11d, and 11e are displayed on the menu item selection screen 10c as second home position icons. A cursor 45 is assigned to the icon 11a located in the center of the menu item selection screen 10c. In this embodiment, the setting menu 21 is assigned to the icon 11a, the mail menu 22 to the icon 11b, the network menu 23 to the icon 11c, the notebook menu 24 to the icon lid, and the folder menu 25 to the icon 11e.

Tilting the cursor key 4 in one of the up, down, right, and left directions with the menu item selection screen 10c displayed (step 302) causes the cursor 45 to move to one of icons 11b, 11c, 11d, and 11e to select a menu item. Then, the submenu items of the selected menu item, that is, the submenu item icons that are base icons of the second hierarchical level, are displayed in the direction perpendicular to the direction in which the cursor key 4 was tilted (step 303). In this embodiment, the cursor key 4 is tilted in the right direction to select the icon 11d assigned to the notebook menu 24 as shown in FIG. SC. When the icon 11d (notebook menu 24) is selected, the small-sized submenu items of the icon are displayed for a predetermined period of time and, as shown in FIG. 5D, icons 11f, 11g, and 11h are displayed as submenu item icons on the menu item selection screen 10c and the submenu items assigned to the icons 11f, 11g, and 11h are displayed in the direction (up and down directions) perpendicular to the direction (right direction) in which the cursor key 4 was tilted. In this embodiment, the submenu items 24a, 24b, and 24c of the notebook menu 24 are displayed as an example of the icons 11f, 11g, and 11h. In addition, when the icon 11d is selected, the icons 11f, 11g, and 11h are displayed and, at the same time, the unselected icons 11a, 11b, 11c, and 11e are dimmed in this embodiment, (step 304). In FIGS. 5C and 5D, the dimmed icons 11a, 11b, 11c, and 11e are indicated by hatching.

When the user wants to backspace the screen to the previous screen, for example, from the screen shown in FIG. 5D to the screen shown in FIG. 5B, with the icons 11f, 11g, and 11h displayed, he or she tilts the cursor key 4 in the direction (left) opposite to the direction (right) in which the cursor key 4 was tilted (step 305). The previous screen is displayed, that is, the screen is returned from the status shown in FIG. 5D to the status shown in FIG. 5B. In this case, the user is able to select a desired menu item again from the icons 11a, 11b, 11c, 11d, and 11e displayed on the menu item selection screen 10c.

If the user does not need to return the cursor key 4 to the original position in step 305, he or she uses the cursor key 4 to select one of submenu items 24a, 24b, and 24c, indicated by the icons 11f, 11g, and 11h (step 306), and presses the cursor key 4 (step 307). Then, a submenu screen 10d, the second display screen, is displayed and the submenu of the selected submenu item is displayed (step 308). In this embodiment, the memo pad 24a is selected as an example of selected submenu item as shown in FIG. 5E.

The user performs a desired operation for the contents of the selected submenu item using the dial keys 2 and the cursor key 4 (step 309). After completion of operation (step 310), the user presses the end key 8 (step 311) to return to the standby screen 10b. In this embodiment, the user performs operation for the submenu of the memo pad 24a, for example, writes a memo and, after writing the memo, presses the end key 8 to return to the standby screen 10b.

Next, with reference to FIGS. 6A-6D, an example of screen transition on the display screen 10a will be described. In FIGS. 6A-6D, with the menu item selection screen 10c displayed, the user tilts the cursor key 4 in the up direction to select the icon 11c assigned to the network menu 23. When the user selects the icon 11c (network menu 23), the small-sized submenu items of the icon are displayed for a predetermined period of time as shown in FIG. 6A. After the predetermined period of time, icons 11i, 11j, and 11k are displayed on the menu item selection screen 10c as submenu item icons as shown in FIG. 6B. The submenu items assigned to the icons 11i, 11j, and 11k are displayed in the direction (right and left directions) perpendicular to the direction (up direction) in which the cursor key 4 was tilted with the cursor 45 on the icon 11i.

In FIGS. 6A-6D, the favorites menu is assigned to the icon 11i, the Internet menu to the icon 11j, and the navigation menu to the icon 11k, respectively, as an example of displayed submenu icons.

When the user tilts the cursor key 4 in the right direction in the status shown in FIG. 6B, the cursor 45 moves to the icon 11k as shown in FIG. 6C and a navigation menu 23c is selected. When the user presses the cursor key 4 in this status, the screen switches to the submenu screen 10d as shown in FIG. 6D and the submenu of the navigation menu 23c is displayed.

In this embodiment, selecting from the submenu of the navigation menu 23c allows the user, via the GPS antenna 13 and location detector 35, to obtain location information and display geographic information based on the location information and to display information on the relative location between the user's location and the destination. The detailed description of the navigation menu 23c is omitted.

Upon completion of the operation for the navigation menu, the user presses the end key 8 to return to the standby screen 10b (see FIG. SA).

In the above embodiment, the screen transition that is made when the user tilts the cursor key 4 in the right direction or in the up direction was described. Similarly, when the user tilts the cursor key 4 in the left direction or in the down direction, the submenu items are displayed, as in the above embodiments, in the direction perpendicular to the direction in which the cursor key 4 was tilted. Therefore, the detailed description is omitted.

As described above, when a menu display is selected, the controller 30 displays a menu screen where the first home position icon constituting the first hierarchical level is displayed in the center of the selection display screen with the second home position icons around it (above, below, right, and left). That is, because up to nine icons, three rows by three columns, may be displayed in this embodiment, four second home position icons may be displayed. When the user selects one of the second home position icons, the second-hierarchical-level submenu icons are displayed in the direction perpendicular to the direction in which the selected second home position icon is located relative to the first home position icon. In other words, when the second home position icon on the right or left side of the first home position icon is selected in this embodiment, the submenu icons may be displayed in the up and down directions with the selected second home position icon as the center. Similarly, when the second home position icon above or below the first home position icon is selected, the submenu icons may be displayed in the right and left direction with the selected second home position icon as the center.

Therefore, in this embodiment, the submenu icons may be displayed in one of the four sections of the selection display screen where a maximum of nine icons may be displayed, and the submenu icons may have functions that depend on the selected second home position icon (depends on the selected path). This makes it possible to display a variety of submenu icons on a cellular phone or a compact PDA that has a limited-size selection display screen. Although a maximum of nine icons are displayed in this embodiment, more icons would give greater efficiency.

In addition, when the user selects a second home position icon in this embodiment, the other second home position icons are dimmed. This clearly indicates the selected second home position icon and the unselected second home position icons on the selection display screen to inform the operator of the selection history.

In addition, when the user selects the first home position icon displayed in the center of the screen in this embodiment, the setting screen used to specify various settings is displayed to allow the user to utilize the first home position icon and the second home position icons. When the user selects one of the second home position icons around the first home position icon displayed in the center of the screen, the selected second home position icon is changed to the submenu icons associated therewith. However, if the second home position icon is changed to the submenu icons immediately after selected, the user cannot understand the selection history, sometimes bewildering the user and leading to an operation error. Thus, in this embodiment, when the user selects a second home position icon, the small-sized icons are displayed for a predetermined time in the position (direction) in which the submenu icons will be displayed. This helps the user understand the selection history correctly and increases the number of submenu icons that may be displayed on the selection display screen.

As described above, because the first-hierarchical-level menu items and the second-hierarchical-level submenu items are displayed on one screen in this embodiment and because the user may select and confirm a menu item simply by operating the cursor key, the operability of the display screen increases. In addition, when selectable lower-hierarchical-level menu items are displayed on the display screen, the other unselected menu items are not displayed to allow the lower-hierarchical-level submenu items to be displayed in free space. This method enables lower hierarchical levels to be sequentially expanded to increase the operability of the display screen configured of multiple hierarchical levels. In particular, this embodiment associates the category of each menu item with a direction in which the cursor moves, making the menu item hierarchy easy to understand.

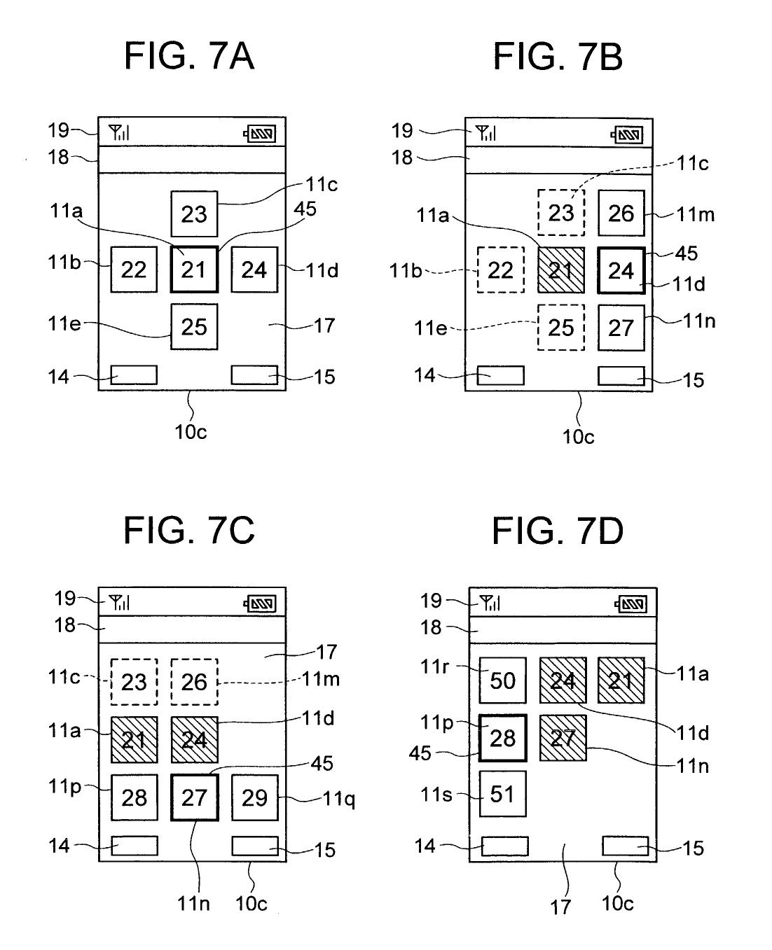

Next, with reference to FIGS. 7A-7D, another example of screen transition on the display screen 10a will be described. The detailed description of the flowchart is omitted because, for the most part, the description is the same as that of the flowchart in FIG. 4.

FIGS. 7A-7D are screen transition diagrams where the menu items are prepared in three or more hierarchical levels. To display the menu icons in three or more hierarchical levels on a screen where a maximum of nine icons may be displayed as in this embodiment, the first home position icon is shifted from the center of the selection display screen to allow the second- or lower-hierarchical-level submenu icons to be displayed thereon. This embodiment will be described below more in detail. When the user presses the cursor key 4 with the standby screen 10b displayed (see FIG. 5A), the display of the display screen 10a switches to the menu item selection screen 10c, the first display screen, as shown in FIG. 7A with the cursor 45 assigned to the icon 11a.

With the menu item selection screen 10c displayed, the user tilts the cursor key 4 in one of four directions—up, down, right, and left—to move the cursor 45 to one of the icons 11b, 11c, 11d, and 11e to select a menu item. Then, the second-hierarchical-level submenu items of the selected menu item are displayed in the direction perpendicular to the direction in which the cursor key 4 was tilted (step 303). In this embodiment, the user tilts the cursor key 4 in the right direction as shown in FIG. 7B to select the icon 11d (menu item 24). Then, submenu items 26 and 27 that constitute the second hierarchical level of the menu item 24 are displayed as icons 11m and 11n in the direction (up and down directions) perpendicular to the direction in which the cursor key 4 was tilted. In FIG. 7B, the unselected icons 11b, 11c, and 11e are dimmed (indicated by broken lines in the figure), while the location where the cursor 45 was displayed before it was moved to the icon 11d, that is, the icon 11a indicated by hatching in the figure, remains displayed on the menu item selection screen 10c (step 304). This allows the user to understand how the cursor 45 moved.

When the user tilts the cursor key 4 in one of up, down, right, and left directions with the screen in FIG. 7B displayed (flowchart steps between step 305 and step 306), the third-hierarchical-level submenu items composed of the lower level items of the second hierarchical level are displayed in the direction perpendicular to the direction in which the cursor key 4 was tilted. In this embodiment, the user tilts the cursor key 4 in the down direction as shown in FIG. 7C to select the icon 11n (submenu item 27). Then, the icon 11n moves and submenu items 28 and 29, which are third-hierarchical-level submenu items of the submenu item 27, are displayed on the sides of the moved icon 11n; that is, those icons are displayed as icons 11p and 11q in the direction (right and left directions) perpendicular to the direction in which the cursor key 4 was tilted (flowchart steps between step 305 and step 306). At the same time, the selected first-hierarchical-level menu items, for example, icons 11a and 11d, are moved such that they do not overlap with the submenu item icons 11n, 11p, and 11q. In addition, the icons 11b and 11e displayed in the positions, with which the icons 11a, 11d, 11n, 11p, and 11q overlap, are erased from the menu item selection screen 10c. Note that the icons 11c and 11m, which are neither selected by the cursor key 4 nor displayed in the positions with which the icons 11a, 11d, 11n, 11p, and 11q overlap, are dimmed on the menu item selection screen 10c (flowchart steps between step 305 and step 306). Also note that the selected icon 11n remains displayed on the menu item selection screen 10c (flowchart steps between step 305 and step 306).

When the user selects one of the displayed submenu items 27, 28, and 29 and presses the cursor key, the fourth-hierarchical-level submenu composed of the lower level items of the selected submenu item are displayed. The detailed description of submenu item display is omitted because it is the same as that shown in FIGS. 5 and 6.

FIG. 7D shows the menu items set up in four hierarchical levels. This screen is displayed when the user tilts the cursor key 4 in the left direction on the screen shown in FIG. 7C and selects the icon 11p. As shown in FIG. 7D, the selected icon 11p moves upward and, above and below the icon 11p, icons 11r and 11s are displayed (flowchart steps between step 305 and step 306). At the same time, the icons dimmed on the menu item selection screen 10c are erased, and the selected icon 11p and the icons 11a, 11d, and 11n, which indicate how the cursor 45 moved, are displayed on the submenu item selection screen 10d such that those icons do not overlap the icons 11p, 11r, and 11s that are submenu items of the fourth hierarchical level (flowchart steps between step 305 and step 306). The detailed description of submenu display is omitted because, even when the menu items are configured in four hierarchical levels, the description is the same as that of FIGS. 5A-5E and FIGS. 6A-6D.

As described above, the cursor movement history displayed on the display screen in this embodiment allows the user to easily identify to which menu item the selected submenu items belong.

In addition, this embodiment, which reduces the number of times the user confirms menu items, improves operability.

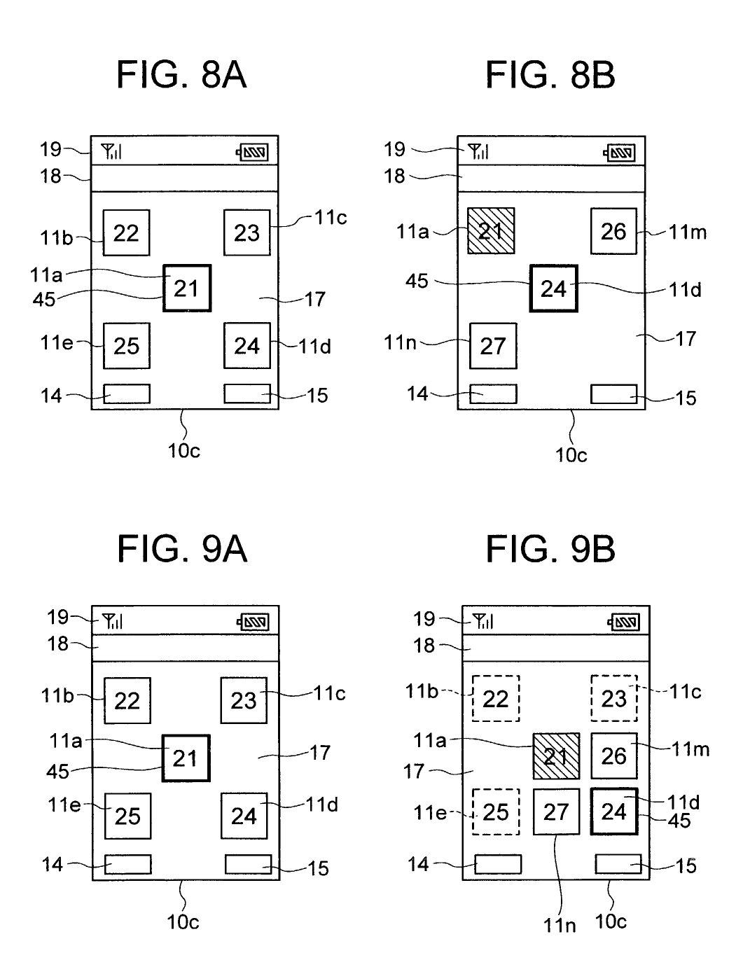

Next, with reference to FIGS. 8A-8B and FIGS. 9A-9B, some examples of screen transition on the display screen 10a will be described. The detailed description of the flowchart is omitted because, for the most part, the description is the same as that of the flowchart in FIG. 4.

FIGS. 8A-8B and FIGS. 9A-9B are screen transition diagrams in which submenu items are displayed diagonally. When the user presses the cursor key 4 with the standby screen 10b (see FIG. 5A) displayed, the display on the display screen 10a switches to the menu item selection screen 10c shown in FIG. 8A with the cursor 45 assigned to the icon 11a. At the same time, the icons 11b and 11d, and the icons 11c and 11e, are displayed each diagonally with respect to the icon 11a. In this embodiment, the cursor key 4 may be tilted in eight directions: up, down right, left, and diagonal directions.

When the user tilts the cursor key 4 in the lower right direction to select the icon 11d with the menu item selection screen 10c in FIG. 8A displayed, the icon 11d moves to the center of the screen as shown in FIG. 8B. The icon 11m, which indicates a submenu item of the icon 11d, is displayed in a direction at an angle significantly different from that of the direction in which the cursor key 4 was tilted (flowchart step in which processing of step 303 is modified). At the same time, the icon 11m is displayed in the diagonally up-right direction of the icon 11d, and the icon 11n in the diagonally down-left direction of the icon 11d, respectively. The unselected icons 11b, 11c, and 11e are erased from the menu item selection screen 10c, and the icon 11a, which indicates the movement history, are displayed with the icons 11d, 11m, and 11n.

FIGS. 9A-9B show another example of diagonal display. When the user tilts the cursor key 4 in the lower right direction to select the icon 11d with the screen in FIG. 9A displayed, the icon 11m and icon 11n, which are the submenu items of the icon 11d, are displayed above, and to the left of, the icon 11d, respectively, as shown in FIG. 9B. The unselected icons 11b, 11c, and 11e are dimmed on the menu item selection screen 10c, and the icon 11a that indicates the movement history remains displayed. The detailed description of submenu item display is omitted because it is the same as that shown in FIGS. 5A-5E and FIGS. 6A-6D.

This embodiment allows the user to tilt the cursor key in one of eight directions as described above. As compared when the cursor key may be tilted only in one of four directions, this embodiment enables more menu icons to be displayed and thus makes the menu screen easier to use.

### Second embodiment

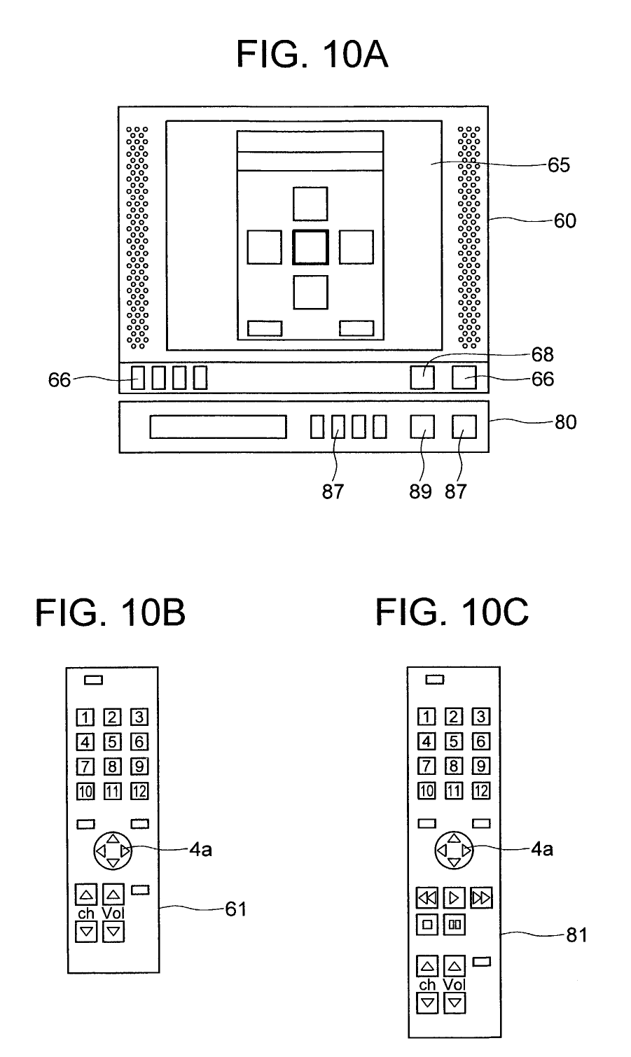

Next, with reference to FIGS. 10A-10C, 11A-11B, 12, and 13, an embodiment in which the menu screen and the display method according to the present invention are applied to an AV system will be described.

FIGS. 10A-10C are diagrams showing the configuration of an Audio-Video (AV) system used in the embodiment of the present invention. Referring to FIG. 10A, the AV system in the embodiment comprises a television set 60 and an externally connected device 80 such as a video cartridge recorder and a DVD player. The television set 60 and the externally connected device 80 are connected via a signal line not shown. The user operates the television set 60 with a remote control unit 61 for use with the television set, shown in FIG. 10B, and the externally connected device 80 with a remote control unit 81 for use with the externally connected device, shown in FIG. 10C, respectively. In this embodiment, a video cartridge recorder is used as an example of the externally connected device 80.

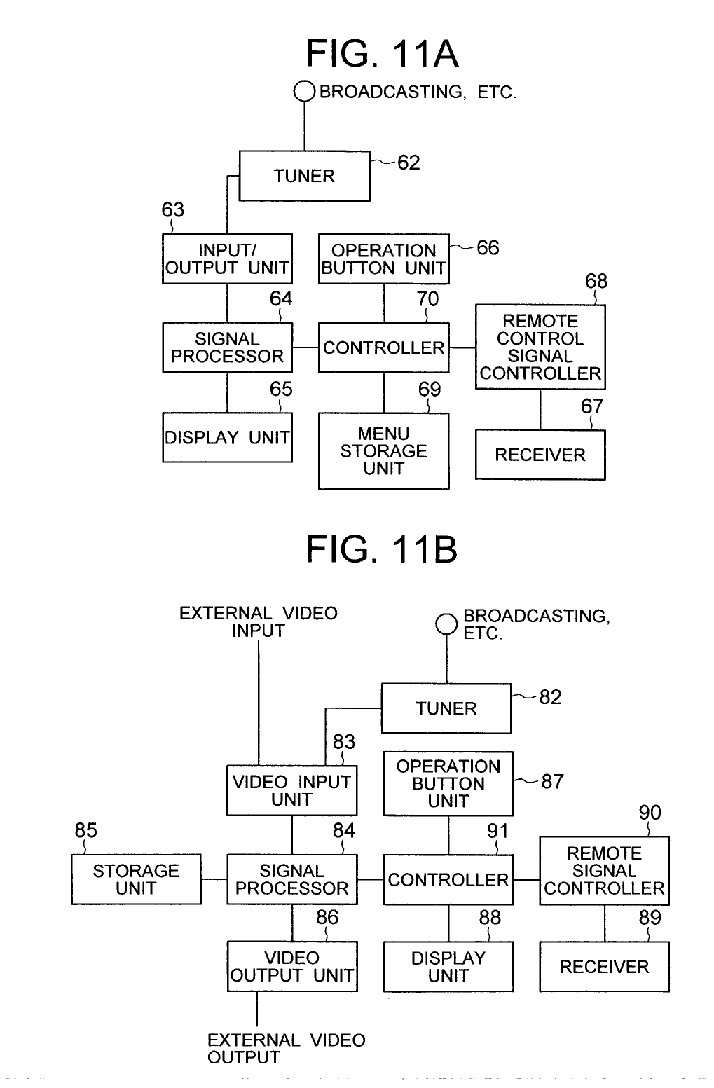

FIGS. 11A-11B are block diagrams showing the hardware configuration of the AV system in the embodiment of the present invention. FIG. 11A is the block diagram of the television set 60, and FIG. 11B is the block diagram of a video cartridge recorder 70.

Referring to FIG. 11A, the television set 60 comprises a tuner 62 that receives signals such as broadcasting signals, an input/output unit 63 that accepts received signals and outputs video signals to the video cartridge recorder 80, a signal processor 64 that processes received signals, a display unit 65 such as a television screen on which processed signals are displayed, an operation button unit 66 used to turn on/off the power, a receiver 67 that receives remote control signals sent from the remote control unit 61, a remote control signal controller 68 that controls remote control signals, a menu storage unit 69 that stores menus set up for the television set 60, and a controller 70 that generally controls the television set 60.

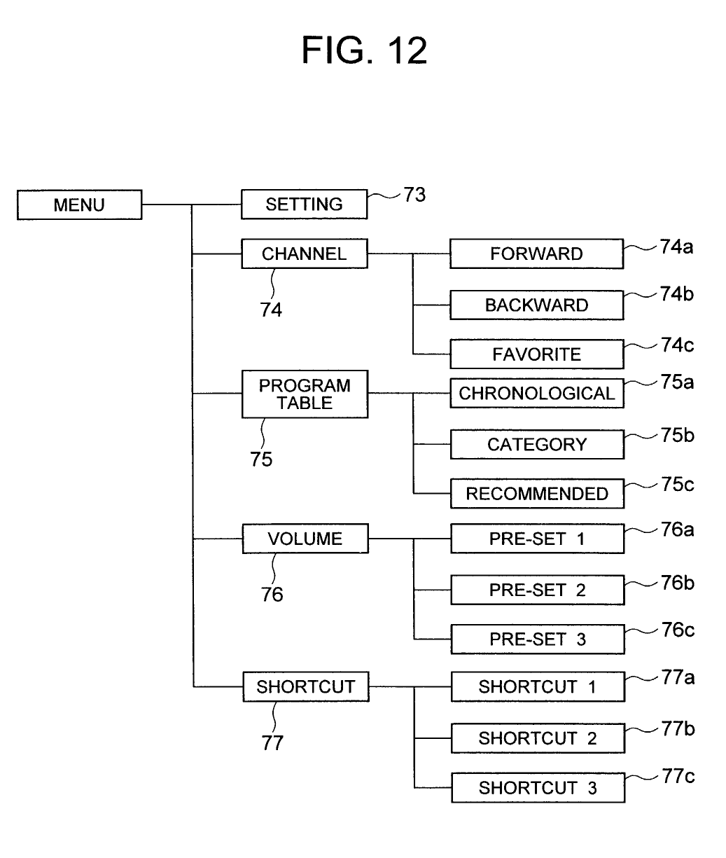

FIG. 12 is a diagram showing an example of the menu structure stored in the menu storage unit 69 of the television set 60 in the embodiment of the present invention. Referring to FIG. 12, the menu items stored in the television set 60 comprise a setting menu 73 used to specify the settings of the television set 60, a channel menu 74 used to display and select channels, a program table menu 75 used to display and select program tables, a volume menu 76 used to adjust and select volumes, and a shortcut menu 77 used to directly select menu items set up in advance. Those menu items constitute the first hierarchical level (major classification). The menu items in the first hierarchical level each have submenus that constitute the second hierarchical level (minor classification).

The channel menu 74 has a submenu 74a used to step up channels, a submenu 74b used to step down channels, and a submenu 74c used to select favorite channels registered in advance.

The program table menu 75 has a submenu 75a used to display the program table in chronological order, a submenu 75b used to display the program table by category such as sports, and a submenu 75c used to display recommended programs.

The volume menu 76 has a submenu 76a used to set and reset the volume of the first sound channel and the second sound channel, a submenu 76b used to set the optimum volume of various channels such as a channel for BS broadcasting or games, and a submenu 76c used to adjust the volume.

The shortcut menu 77 has a submenu 77a used to directly select from registered channels categorized, for example, by category, a submenu 77b used to split the screen, for example, from one screen to two screens or from two screens to four screens, and a submenu 77c used to switch the screen, for example, from the screen of the television set 60 to the screen of the video cartridge recorder 70.

Referring to FIG. 11B, the video cartridge recorder 80 comprises a tuner 82 that receives signals such as broadcasting signals, a video input unit 83 that receives video signals received by the tuner 82 or video signals received from an external unit, a signal processor 84 that processes received video signals, a storage unit 85 that stores processed video signals or menu items, a video output unit 86 that outputs processed video signals, an operation button unit 87 that does playback or fast-forwarding, a display unit 88 that displays times or counters, a receiver 89 that receives remote control signals sent from a remote control unit 81, a remote signal controller 90 that controls remote control signals, and a controller 91 that generally controls the video cartridge recorder 80.

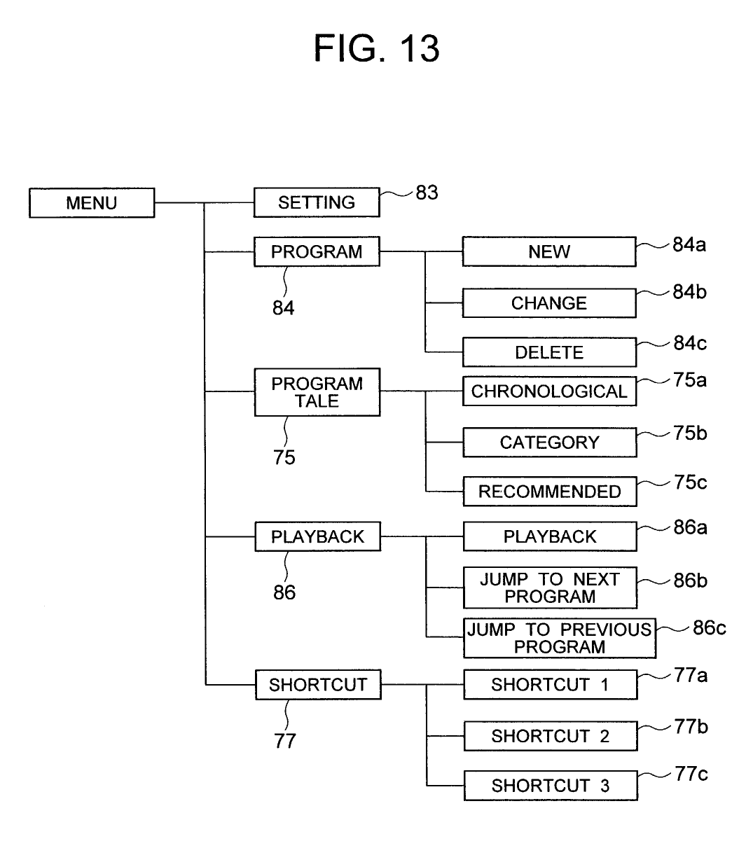

FIG. 13 is a diagram showing an example of the menu structure stored in the storage unit 85 of the video cartridge recorder 80 in the embodiment of the present invention. Referring to FIG. 13, the menu items stored in the video cartridge recorder 80 comprises a setting menu 83 used to specify the settings of the video cartridge recorder 80, a program menu 84 used to schedule program recording, a program table menu 75 used to display and select a program table, a playback menu 86 used to play back recorded videos, and a shortcut menu 77 used to directly select menu items set up in advance. Those menu items constitute the first hierarchical level (major classification). The menu items of the first hierarchical level each have submenus that constitute the second hierarchical level (minor classification).

The program menu 84 has a submenu 84a used to schedule new program recording, a submenu 84b used to change programmed contents, and a submenu 84c used to delete programmed contents.

The playback menu 86 has a submenu 86a used to play back recorded videos, a submenu 86b used to jump to a video recorded after the video being played back, and a submenu 86c used to jump to a video recorded before the video being played back. Because the menu structure of the program table menu 75 and the shortcut menu 77 is the same as that of the television set 60, the detailed description is omitted.

The first and second hierarchical level menus stored in the television set 60 and the video cartridge recorder 80 are displayed on the TV screen as icons. The user uses the remote control unit 61 of the TV or the remote control unit 81 of the video cartridge recorder to select from the displayed icons. The menu screen changes from one screen to another and a desired menu screen is displayed on the TV screen. Then, the user confirms the menu screen with the remote control unit 61 of the TV or the remote control unit 81 of the video cartridge recorder. When the operation of the displayed menu screen is completed, the user operates the remote control unit 61 of the TV or the remote control unit 81 of the video cartridge recorder to return to the screen of the TV or the externally connected device. Because the menu item display method and the menu screen transition in this embodiment are the same as those of the first embodiment, the detailed description is omitted. With the exception of the menu structure, this embodiment is similar in operation to a conventional AV system; therefore, the detailed description is omitted.

As described above, this embodiment makes the menu item selection/confirmation screen smaller, thus allowing the user to select or confirm menu items without disturbing the contents displayed on the TV screen.

Another advantage with this embodiment is that, because a remote control unit may be made compact without decreasing operability, the structure of a remote control unit becomes simple.

### Third Embodiment

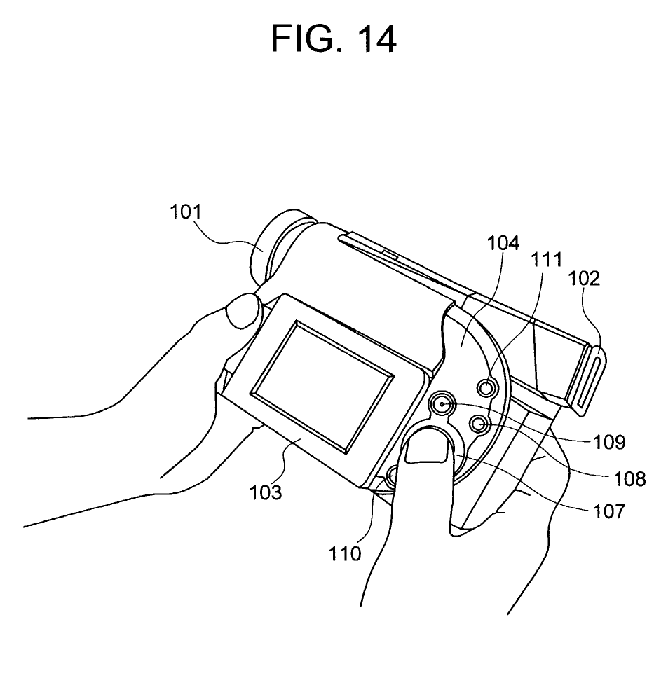

Next, with reference to FIGS. 14-16, an embodiment will be described in which the menu screen and the display method according to the present invention are applied to a Digital Versatile Disc (DVD) camera, a video camera, and a hard disk camera. In the description of this embodiment, the menu screen and the display method applied to a DVD camera will be described as an example.

FIG. 14 is a diagram showing how the DVD camera in the embodiment of the present invention is used. Referring to FIG. 14, the DVD camera in the embodiment comprises a camera lens 101, a finder 102, a monitor 103, and an operation unit 104. The operation unit 104 comprises a cursor key 107, a menu key 108, a navigation key 109, a stop key 110, and a selection key 111. The DVD camera in the embodiment, on which the operation keys of the operation unit 104 are arranged in one section, allows the user to operate the operation keys with the thumb as shown in FIG. 13.

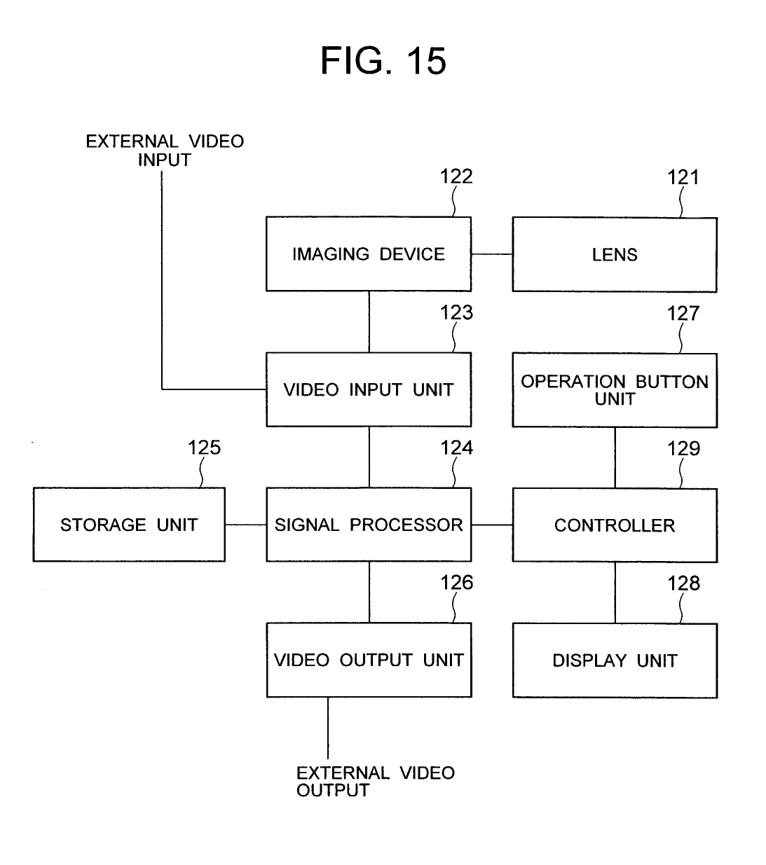

FIG. 15 is a block diagram showing the hardware configuration of the DVD camera in the embodiment of the present invention. Referring to FIG. 15, the DVD camera comprises a lens 121 that determines the imaging position of a subject, an imaging device 122 that images a subject, a video input unit 123 that receives video signals imaged by the imaging device 122, a signal processor 124 that processes received image signals, a storage unit 125 in which processed video signals and menu items are stored, a video output unit that outputs processed video signals to an external device, an operation button unit 127 used to perform DVD camera operations, a display unit 128 that displays video signals processed by the signal processor, and a controller 129 that generally controls the DVD camera. As shown in FIG. 15, the lens 121 and the imaging device 122 constitute the camera lens 101, the display unit 128 constitutes the monitor 103, and the operation button unit 127 are composed of operation keys.

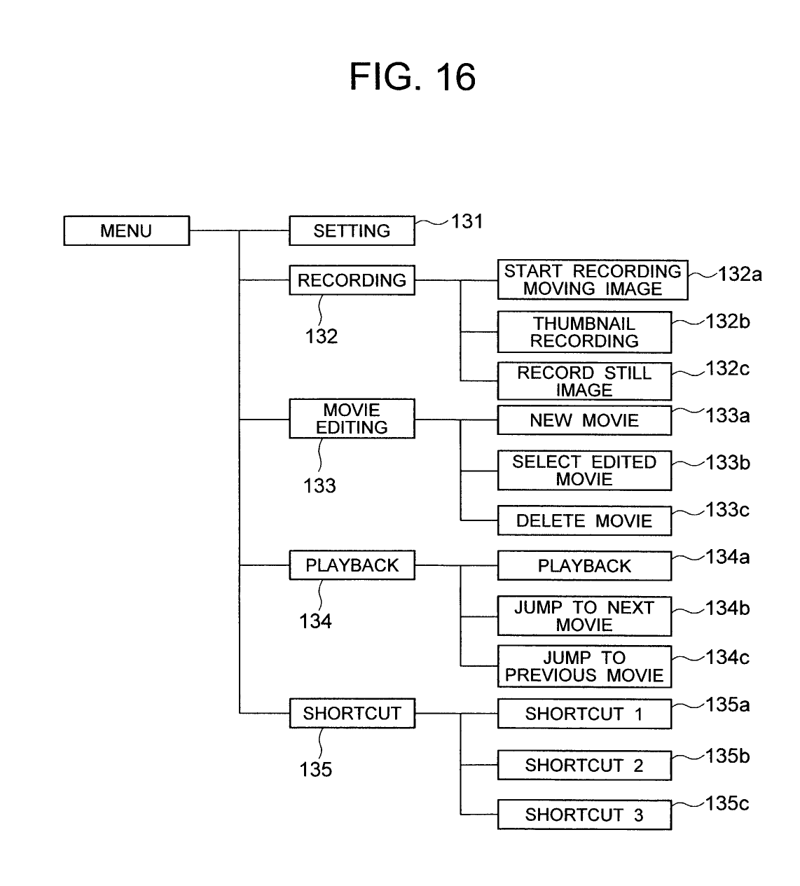

FIG. 16 is a diagram showing an example of the menu structure stored in the storage unit 125 of the DVD camera in the embodiment of the present invention. Referring to FIG. 16, the menu items stored in the DVD camera comprise a setting menu 131 used to specify the settings of the DVD camera, a recording menu 132 used to display and select a recording mode, a movie editing menu 133 used to edit recorded image signals (movie), a playback menu 134 used to play back recorded movies, and a shortcut menu 135 used to directly select menu items set up in advance. Those menu items constitute the first hierarchical level (major classification). The menu items of the first hierarchical level each have submenus that constitute the second hierarchical level (minor classification).

The recording menu 132 has a submenu 132a used to start recording motion videos, a submenu 132b used to do thumbnail recording, and a submenu 132c used to record still images.

The movie editing menu 133 has a submenu 133a used to edit newly recorded movies, a submenu 133b used to call edited movies for selection of a movie to be edited again, and a submenu 133c used to delete unnecessary movies.

The playback menu 134 has a submenu 134a used to play back movies, a submenu 134b used to jump to a movie recorded after the video being played back, and a submenu 134c used to jump to a video recorded before the video being played back.

The shortcut menu 135 has submenus 135a, 135b, and 135c for frequently used menus, for example, frequently used editing mode commands.

The first and second hierarchical level menus stored in the DVD camera described above are displayed as icons on the monitor 103. When the user operates the operation unit 104 to select an icon from the displayed icons, the menu screen on the monitor 103 changes from one screen to another and a desired menu screen appears on the monitor 103. Then, the user confirms the menu screen through the operation unit 104. When the operation on the displayed menu screen is completed, the user operates the operation unit 104 to return the screen display on the monitor 103, for example, to the screen ready for recording. Because the menu item display method and the menu screen transition in this embodiment are the same as those of the first embodiment, the detailed description is omitted.

The DVD camera in the embodiment, on which the operation keys are arranged in one section, ensures better display screen operability.

Another advantage with the embodiment is that, because the user can hold the DVD camera firmly, stable screen operation is possible.

### Fourth Embodiment

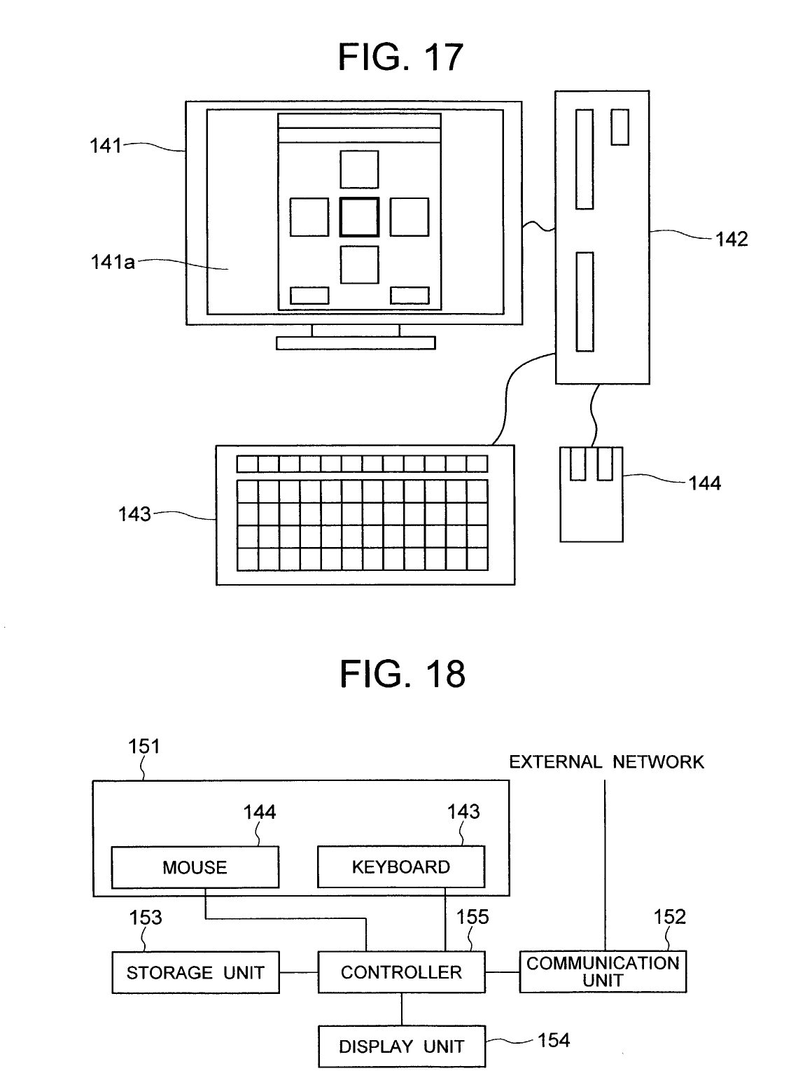

With reference to FIGS. 17-19, an embodiment will be described in which the menu screen and the display method according to the present invention are applied to a Personal Computer (PC) system.

FIG. 17 is an external configuration diagram of the PC system in the embodiment of the present invention. Referring to FIG. 17, the PC system in this embodiment comprises a display 141, a PC system unit 142, a keyboard 143, and a mouse 144.

FIG. 18 is a block diagram showing the hardware configuration of the PC system in the embodiment of the present invention. Referring to FIG. 18, the PC system comprises an input unit 151 composed of the keyboard 143 and the mouse 144, a communication unit 152 connected to external networks, a storage unit 153 in which data entered from the input unit 151, data downloaded from external networks, and menu items are stored, a display unit 154 that displays entered data and menu items, and a controller that generally controls the PC system.

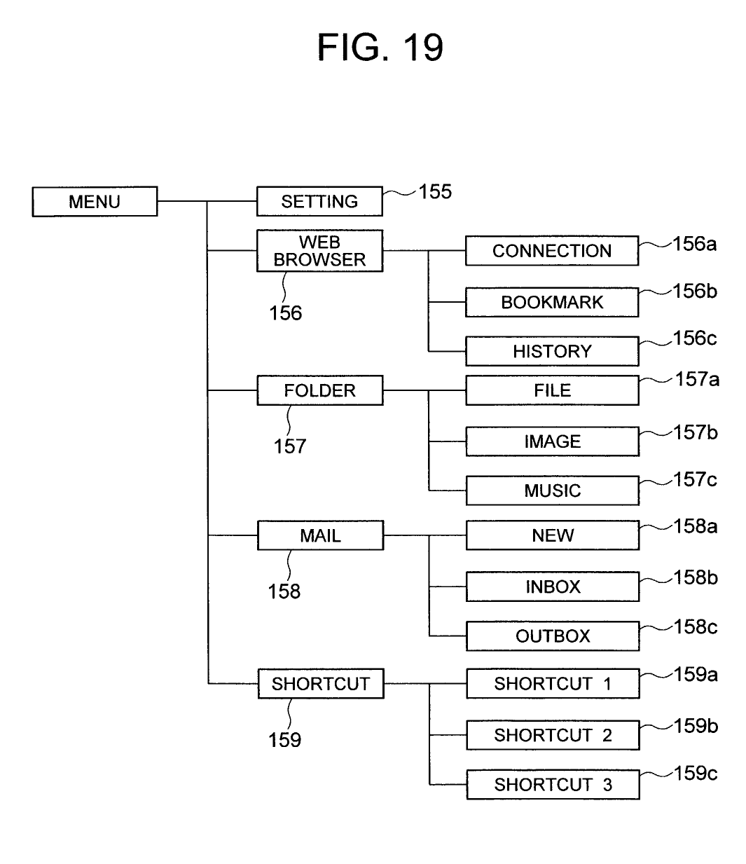

FIG. 19 is a diagram showing an example of the menu structure stored in the storage unit 153 of the PC system in the embodiment of the present invention. Referring to FIG. 19, the menu items stored in the PC system comprise a setting menu 155 used to specify the settings of the PC system, a web browser menu 156 used to connect to web sites on the Internet, a folder menu 157 used to save and call data entered from the input unit 151 or data downloaded from external networks, a mail menu 158 used to send or receive mails, and a shortcut menu 159 used to directly select menu items set up in advance. Those menu items constitute the first hierarchical level (major classification). The menu items in the first hierarchical level each have submenus that constitute the second hierarchical level (minor classification).

The web browser menu 156 has a submenu 156a used to connect to web sites, a submenu 156b used to display and select bookmarks for connection to frequently visited web sites registered in advance, and a submenu 156c used to display the history of web sites to which the system connected.

The folder menu 157 has a submenu 157a used to save and call files, a submenu 157b used to save and call image data downloaded from web sites, and submenu 157c used to save and call music data downloaded from web sites.

The mail menu 158 has a submenu 158a used to create mails, a submenu 158b used to display received mails, and a submenu 158c used to display sent mails.

The shortcut menu 159 has submenus 159a, 159b, and 159c for frequently used functions, for example, for starting the mail system and for displaying bookmarks.

The first and second hierarchical level menus stored in the PC system are displayed as icons on a display screen 141a of the display 141. When the user operates the keyboard 143 and the mouse 144 to select an icon from the displayed icons, the menu screen on the display screen 141a changes from one screen to another and a desired menu screen appears on the display screen 141a. Then, the user confirms the menu screen. When the operation on the displayed menu screen is completed, the user operates the keyboard 143 and the mouse 144 to return the display on the display screen 141a, for example, to the standby screen on which the wallpaper is displayed. Because the menu item display method and the menu screen transition in this embodiment are the same as those of the first embodiment, the detailed description is omitted.

As described above, the menu items displayed as icons on the PC display screen are displayed on one screen in this embodiment, the PC display screen may be fully utilized.

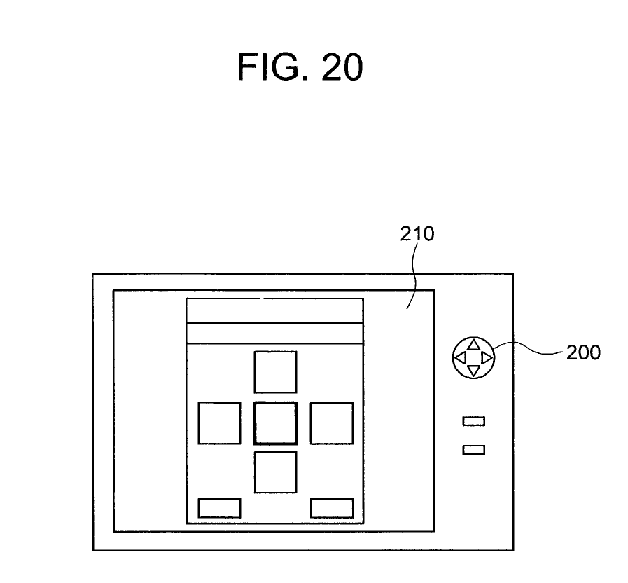

The menu structure in the embodiment may be applied also to an Internet appliance terminal shown in FIG. 20. On the Internet appliances terminal shown in FIG. 20, the user can use a cursor key 200 and a touch panel 210 to implement the menu item display method and menu screen transition as in the PC system.

### Fifth Embodiment

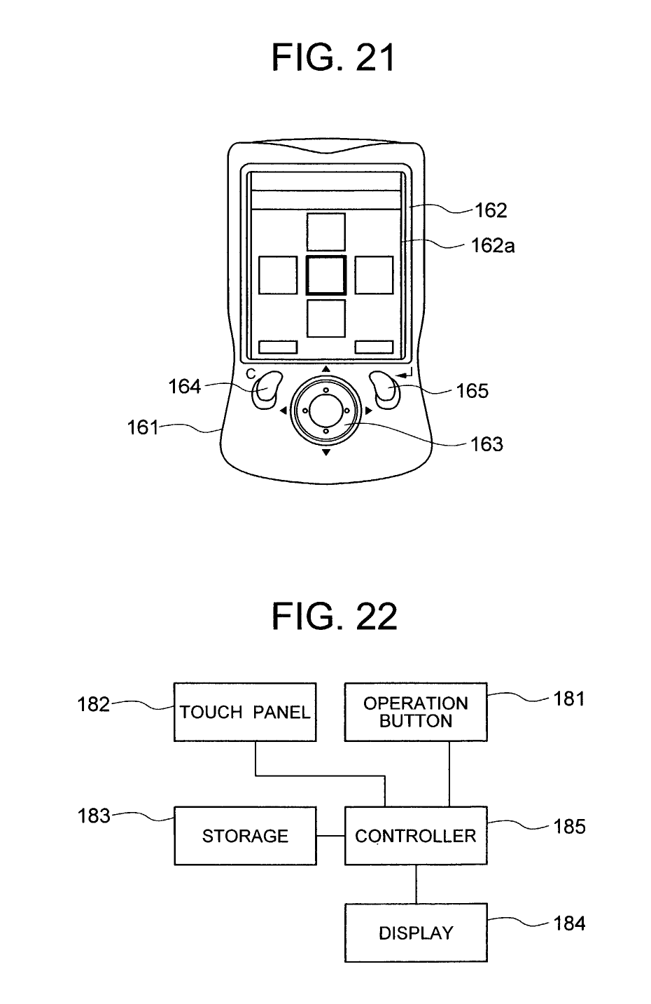

Next, with reference to FIGS. 21-23, an embodiment will be described in which the menu screen and the display method according to the present invention are applied to a PDA terminal.

FIG. 21 is an external configuration diagram of a PDA terminal in the embodiment of the present invention. Referring to FIG. 21, the PDA terminal in the embodiment comprises a terminal body 161, a display unit 162 provided on the terminal body 161, a cursor key 163, a left soft key 164, and a right soft key 165. The PDA terminal is designed such that the user enters data, for example, schedule data, using a stylus (not shown) with the stylus in the right hand and with the PDA terminal in the left hand.

FIG. 22 is a block diagram showing the hardware configuration of the PDA terminal in the embodiment of the present invention. Referring to FIG. 22, the PDA terminal comprises an operation button unit 181 composed of the cursor key 163, left soft key 164, and right soft key 165, a touch panel 182 constituting a display screen 162a of the display unit 162, a storage unit 183 in which data entered from the operation button unit 181 and the touch panel 182 and menu items are stored, a display unit 184 that displays entered data or recorded data on the display screen 162a, and a controller 185 that generally controls the PDA terminal.

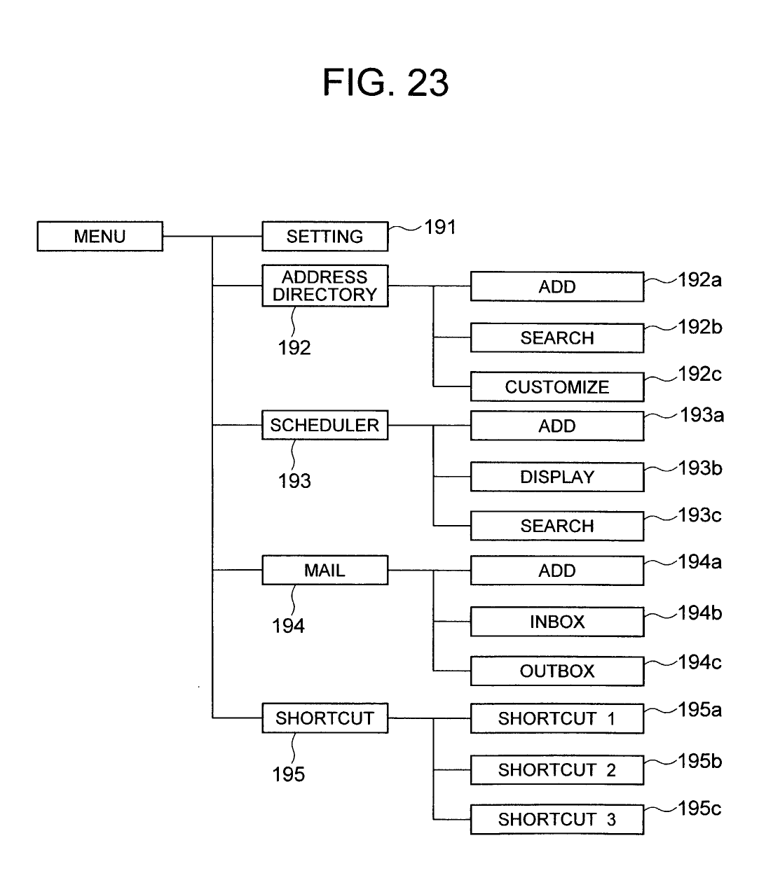

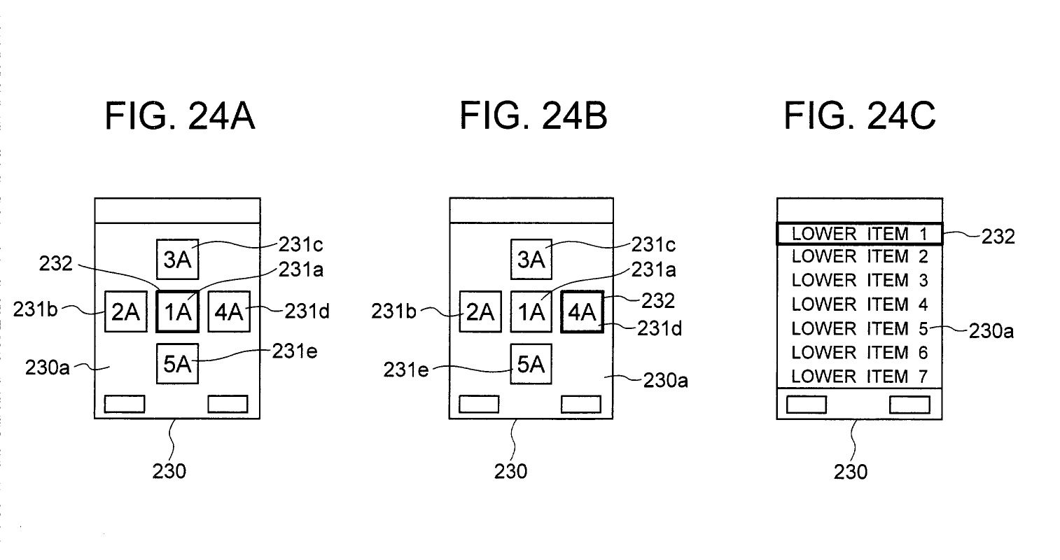

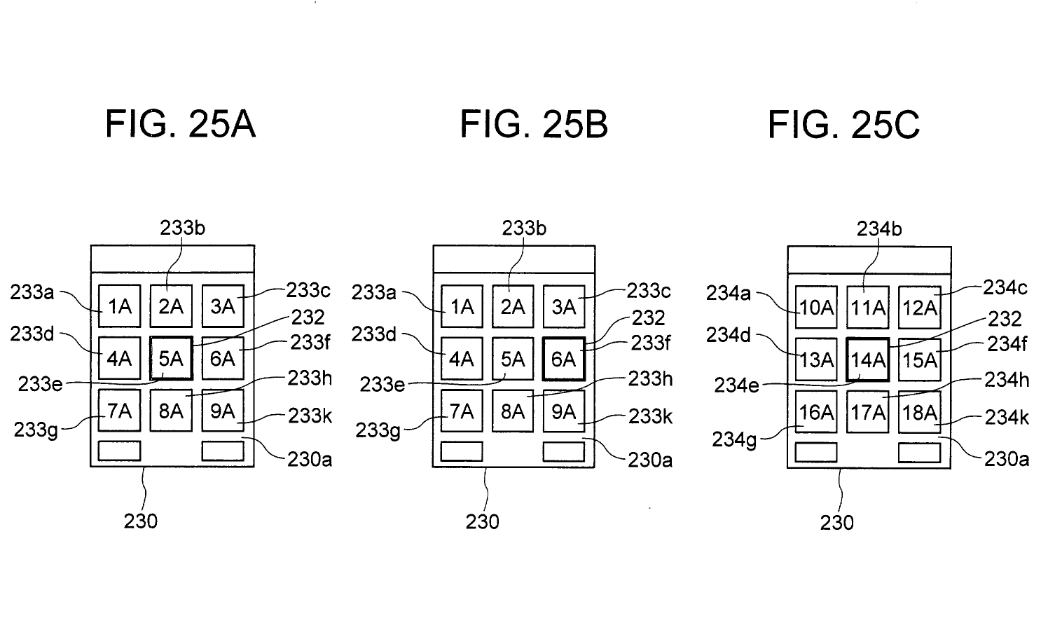

FIG. 23 is a diagram showing an example of the menu structure stored in the menu storage unit 183 of the PDA terminal in the embodiment of the present invention. Referring to FIG. 22, the menu items stored in the PDA terminal comprise a setting menu 191 used to specify the settings of the PDA terminal, an address directory menu 192 used to add entries to or call entries from an address directory, a scheduler menu 193 used to add or display schedules, a mail menu 194 used to send or receive mails, and a shortcut menu 195 used to directly select menu items set up in advance. Those menu items constitute the first hierarchical level (major classification). The menu items in the first hierarchical level each have submenus that constitute the second hierarchical level (minor classification).

The address directory menu 192 has a submenu 192a used to add addresses, telephone numbers, and so on to the address directory, a submenu 192b used to search through the address directory, and a submenu 192c used to customize the address directory.

The scheduler menu 193 has a submenu 193a used to add schedules, a submenu 193b used to display schedules, and a submenu 193c used to search through the schedules.

The shortcut menu 195 has submenus 195a, 195b, and 195c for connecting directly to frequently used functions such as an entry-adding menu for an address directory or a scheduler or a mail creation menu. Because the mail menu 194 is the same as that of the PC system described above, the detailed description is omitted.

The first and second hierarchical level menus stored in the PDA terminal are displayed as icons on a display screen 162a of the display 162. When the user operates the cursor key 163, left soft key 164, and right soft key 165 to select an icon from the displayed icons, the menu screen on the display screen 162a changes from one screen to another and a desired menu screen appears on the display screen 162a. Then, the user confirms the menu screen with the cursor key 163. When the operation on the displayed menu screen is completed, the user operates the cursor key 163, left soft key 164, and right soft key 165 to return the display on the display screen 162a, for example, to the standby screen. Because the menu item display method and the menu screen transition in this embodiment are the same as those of the first embodiment, the detailed description is omitted.

One-handed PDA terminal operation implemented in this embodiment allows the user to select and confirm a menu item with the hand on the cursor key or soft key. This increases the operability of the display screen.

The ability to display more menu items on a limited-size display screen in the embodiment described above, as well as the ability to select a menu item with one operation key, increases the ease of use and operability of the display screen.

Backspacing the screen with one operation key in this embodiment makes menu selection easy.

Operation history displayed on the display screen in this embodiment allows the user to identify the menu hierarchy of menu items and to keep track of the menu items selected by him or her.

Association of the category of each menu item with the cursor movement direction in this embodiment makes it easier to memorize categories.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method of displaying information on a screen wherein a plurality of menu item icons are displayed on a first display screen and, when a desired menu item icon is selected from the plurality of displayed menu item icons, submenu items set up for the selected desired menu item are displayed, said method comprising the steps of:
displaying a first home position icon in a center of said first display screen with second home position icons around said first home position icon, said menu item icons displayed on said first display screen including the first home position icon and the second home position icons,
accepting a selection of a desired menu item from said second home position icons displayed on said first display screen and displaying submenu items, which are set up for the selected menu item, as icons around the selected second home position icon; and
accepting a selection of a desired submenu item from the submenu items displayed as the icons and displaying lower level items, which are set up for the selected submenu item, around the icon with at least the first home position icon and the selected second home position icon on said first display screen.

2. A method according to claim 1,
wherein the second home position icons displayed on said first display screen but not selected are dimmed on said first display screen.

3. A method according to claim 1,
wherein said first home position icon located in the center of said first display screen has a setting function and, when a selection of said first home position icon is accepted, a setting screen is displayed.

4. A method according to claim 1,
wherein the lower level items set up for the submenu items are each including a plurality of hierarchical levels and, when a selection of one of the lower level items is accepted, submenus set up for hierarchical levels lower than the selected lower level item are expanded sequentially on said first display screen.

5. A method according to claim 4,
wherein the lower hierarchical level submenus are expanded and displayed with the selected higher hierarchical level items displayed on said first display screen.

6. A method of displaying information on a screen wherein a plurality of menu item icons are displayed on a first display screen and, when a desired menu item icon is selected from the plurality of displayed menu item icons, submenu items set up for the selected desired menu item are displayed, said method comprising the steps of:
displaying a first home position icon in a center of said first display screen with four second home position icons around said first home position icon, said menu item icons displayed on said first display screen including the first home position icon and the second home position icons,
accepting a selection of a desired menu item from said four second home position icons displayed on said first display screen and displaying submenu items, which are set up for the selected menu item, in a space as icons around the selected second home position icon;
accepting a selection of a desired submenu item from the submenu items displayed as the icons and displaying lower level items, which are set up for the selected submenu item, in a space around the icon; and
when a desired lower level item is selected from the displayed lower level items, expanding and displaying items lower than the selected lower item in a space around the selected lower item with at least the first home position icon and the selected second home position icon on said first display screen.

7. A method according to claim 6,
wherein the second home position icons displayed on said first display screen but not selected are dimmed on said first display screen.

8. A method according to claim 6,
wherein said first home position icon located in the center of said first display screen has a setting function and, when a selection of said first home position icon is accepted, a setting screen is displayed.

9. A method according to claim 6,
wherein the lower level items set up for the submenu items each include of a plurality of hierarchical levels and, when a selection of one of the lower level items is accepted, submenus set up for hierarchical levels lower than the selected lower level item are expanded sequentially on said first display screen.

10. A method according to claim 9,
wherein the lower hierarchical level submenus are expanded and displayed with the selected higher hierarchical level items displayed on said first display screen.

11. A method of displaying information on a screen wherein a plurality of menu item icons are displayed on a first display screen and, when a desired menu item icon is selected from the plurality of displayed menu item icons through an operation of an operation unit, submenu items set up for the selected desired menu item are displayed on a second display screen, said method comprising the steps of:
displaying a first home position icon in a center of said first display screen with four second home position icons above, below, to a right, and to a left of said first home position icon, said menu item icons displayed on said first display screen including the first home position icon and the second home position icons,
selecting a desired menu item from said four second home position icons displayed on said first display screen through an operation of the operation unit and displaying submenu items, which are set up for the selected menu item, as icons in a direction perpendicular to an operation direction of the operation unit with unselected second home position icons dimmed on said first display screen; and
when a desired submenu item is selected from the icons through an operation of the operation unit, submenus set up for the submenu item are displayed on a second display screen.

12. A method according to claim 11,
wherein said first home position icon located in the center of said first display screen has a setting function and, when said first home position icon is selected, a setting screen is displayed.

13. A method according to claim 11,
wherein, when one of the second home position icons is selected, the submenu items of the selected menu item are displayed as small-size icons in a display position of the selected second home position icon for a predetermined time and, after the predetermined time, the submenu items are displayed as the icons.
